(19) United States
(12) Patent Application Publication
(10) Pub. No.: US 2022/0063284 A1
(43) Pub. Date: Mar. 3, 2022

(54) IMAGE FORMING APPARATUS

(71) Applicant: Konica Minolta, Inc., Tokyo (JP)

(72) Inventor: Takeshi YAMAZAKI, Tokyo (JP)

(21) Appl. No.: 17/388,472

(22) Filed: Jul. 29, 2021

(30) Foreign Application Priority Data
Aug. 25, 2020 (JP) 2020-141854

(51) Int. Cl. B41J 2/17; B41J 2/175

(52) U.S. Cl. CPC B41J 2/1721; B41J 2/17596; B41J 2/17509

(57) ABSTRACT

An image forming apparatus incudes: a reservoir that stores a liquid; a moving part that is movable in a predetermined direction; and a circulation path part that allows the liquid in the reservoir to circulate between the reservoir and the moving part, wherein the moving part includes: an ejector that ejects the liquid to a recording medium; a communication path part that communicates with an ejection flow path of the ejector and communicates with the circulation path part; and a pressure adjuster that is provided in a portion of the communication path part, the portion communicating with the circulation path part, and that adjusts a pressure in order that the liquid supplied from the circulation path part passes through the ejector and returns to the circulation path part.

The entire disclosure of Japanese patent Application No. 2020-141854, filed on Aug. 25, 2020, is incorporated herein by reference in its entirety.

### BACKGROUND

### Technological Field

The present invention relates to an image forming apparatus.

### Description of the Related art

Conventionally, there has been known an image forming apparatus that forms an image on a recording medium by ejecting a liquid onto a recording medium such as, for example, an inkjet-type image forming apparatus. Some of such known image forming apparatuses are of scanning type or one-pass type.

In an image forming apparatus of scanning type, a reservoir that stores a liquid is disposed in a carriage (recording head) capable of scanning along the width direction of a recording medium (see, for example, JP 2005-067135 A) and, while the recording head is moving along the width direction, an ejector in the recording head ejects a liquid onto the recording medium.

On the other hand, in an image forming apparatus of one-pass type, a liquid is supplied to a fixed recording head from a reservoir disposed outside the recording head, and an ejector in the recording head ejects a liquid onto a recording medium being conveyed.

Those image forming apparatuses may be problematic in that, when any of individual ejection holes (nozzles) in the ejector ejects no liquid for a certain period of time, that ejection hole becomes dry. An image forming apparatus of scanning type suppresses the occurrence of such problem by ejecting a liquid to the outside of a liquid ejection area in the recording medium. An image forming apparatus of one-pass type suppresses the occurrence of such problem by circulating the liquid between the recording head and the reservoir.

However, an image forming apparatus of one-pass type has difficulty in ejecting a liquid (for example, ejecting a liquid to the outside of a liquid ejection area) when the ejector is being refreshed because the recording head is fixed. On the other hand, an image forming apparatus of scanning type poses a problem of an increased amount of a waste liquid because a liquid is ejected for maintenance of the ejector as well as for inhibiting the ejector from becoming dry, and thus the .liquid is frequently ejected.

### SUMMARY

An object of the present invention is to provide an image forming apparatus capable of suppressing an increase in the amount of a waste liquid while inhibiting the ejector from becoming dry.

To achieve the abovementioned object, according to an aspect of the present invention, an image forming apparatus reflecting one aspect of the present invention comprises: a reservoir that stores a liquid; a moving part that is movable in a predetermined direction; and a circulation path part that allows the liquid in the reservoir to circulate between the reservoir and the moving part, wherein the moving part includes: an ejector that ejects the liquid to a recording medium, a communication path part that communicates with an ejection flow path of the ejector and communicates with the circulation path part; and a pressure adjuster that is provided m a portion of the communication path part, the portion communicating with the circulation path part, and that adjusts a pressure in order that the liquid supplied from the circulation path part passes through the ejector and returns to the circulation path part.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a schematic configuration of an image forming apparatus according to an embodiment of the present invention;

FIG. 2 is a block diagram illustrating a main functional configuration of the image forming apparatus;

FIG. 3 is a diagram schematically illustrating a liquid flow path system applied to an embodiment of the present invention;

FIG. 4 is a diagram illustrating a first pressure generator or a second pressure generator;

FIG. 5 is a diagram schematically illustrating a liquid flow path system according to a modification;

FIG. 6 is a diagram illustrating a moving part according to a modification; and

FIG. 7 is a diagram illustrating a moving part according to a modification.

### DETAILED DESCRIPTION OF EMBODIMENTS

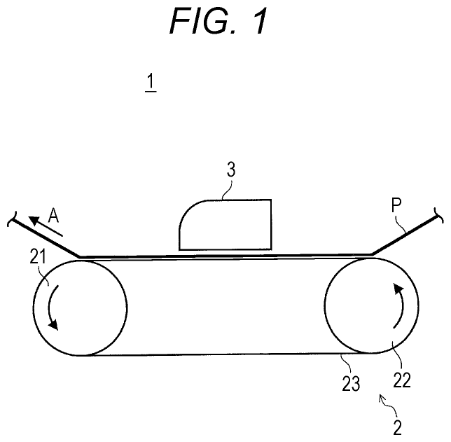

Hereinafter, one or more embodiments of the present invention will be described with reference to the drawings. However, the scope of the invention is not limited to the disclosed embodiments. FIG. 1 is a diagram illustrating a schematic configuration of an image forming apparatus 1 according to an embodiment of the present invention.

As illustrated in FIG. 1, the image forming apparatus 1 is an inkjet-type image forming apparatus including a belt conveyor device 2, a recording head 3, and others.

In the belt conveyor device 2, an endless conveyor belt 23 having a predetermined width is stretched over a driving roller 21 and a driven roller 22 that are disposed apart by a predetermined distance in parallel. An upper surface of the conveyor belt 23 spread over the driving roller 21 and the driven roller 22 is a placement surface on which a recording medium P is to be placed in close contact therewith.

In the belt conveyor device 2, the driving roller 21 rotates at a predetermined speed counterclockwise as indicated in FIG. 1 (see the arrow), driven by rotation of a vertical scanning; motor, thereby rotationally moving the conveyor belt 23 spread between the driving roller 21 and the driven roller 22. As a result of such operation, the recording medium P placed on the upper surface of the conveyor belt 23 is conveyed in the direction of the arrow A in the figure, the direction being the vertical scanning direction.

As the recording medium P, a recording medium usually used for inkjet recording, such as, for example, paper, fabric, a plastic film, or a glass plate, can be used. The recording medium P may be in the form of a sheet cut to a predetermined size, or may be in the form of a long medium continuously fed from an original roll wound in a roll shape.

Note that a belt cleaning device (not illustrated) is provided on the belt conveyor device 2 on the side opposite to the surface for conveying the recording medium P. The belt cleaning device removes ink and foreign. matters adhering to the conveyor belt 23.

The recording head 3 includes a plurality of inkjet heads and is disposed above, and away by a certain distance from, the surface of the conveyor belt 23 on which the recording medium P is placed. The recording head 3 records a desired image on the recording medium P by ejecting ink droplets from a large number of nozzles provided on the lower surface of the recording head 3, the recording medium P being conveyed by rotational movement of the conveyor belt 23.

In the present embodiment, a shuttle-type recording head is used as the recording head 3, the shuttle-type recording head being mounted on a carriage (not illustrated) and reciprocating along a horizontal scanning direction orthogonal to the conveyance direction of the recording medium P, which is intermittently conveyed. That is, the image forming apparatus 1 according to the present embodiment is a scanning-type image forming apparatus. In this case, during recording, the driving roller 21 is controlled to drive the conveyor belt 23 into an intermittent operation in which a standby state and a driven state are alternately repeated.

In addition, a liquid is supplied to the recording head 3 via a circulation path part from a reservoir provided outside the recording head 3. Specifically, in the present embodiment, a liquid is circulated through the circulation path part between the recording head 3 and the reservoir. A liquid flow path system 200 including the recording head, the reservoir, and the circulation path part will be described later.

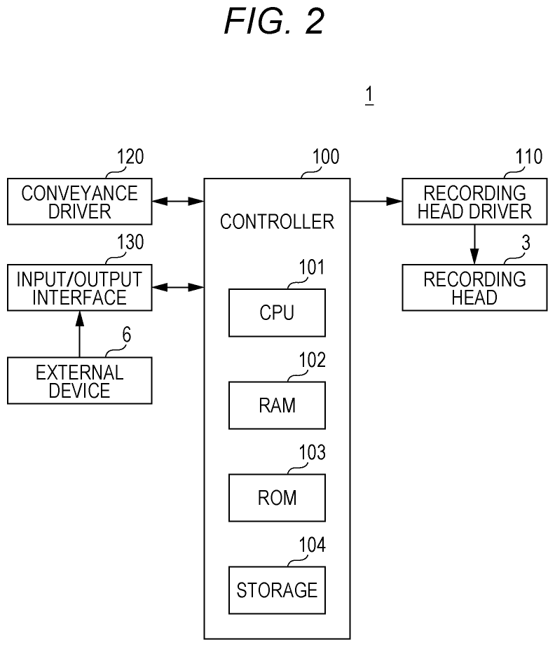

FIG. 2 is a block diagram illustrating a main functional configuration of the image forming apparatus 1. The image forming apparatus 1 includes a controller 100, a recording head driver 110, a conveyance driver 120, and an input/output interface 130.

The controller 100 includes a central processing unit (CPU) 101, a random access memory (RAM) 102, a read only memory (ROM) 103, and a storage 104.

The CPU 101 reads various control programs and setting data stored in the ROM 103, stores the programs and data into the RAM 102, and executes the programs to perform various computations. In addition, the CPU 101 exerts centralized control of the overall operation of the image forming apparatus 1.

The RAM 102 provides the CPU 101 with a working memory space and stores temporary data. The RAM 102 may include a nonvolatile memory.

The ROM 103 stores various control programs to be executed by the CPU 101, setting data, and so on. Instead of the ROM 103, a rewritable nonvolatile memory such as an electrically erasable programmable read-only memory (EEPROM) or a flash memory may be used.

The storage 104 stores a print job (instruction to record an image) input from an external device 6 via the input/output interface 130 and image data related to the print job. As the storage 104, for example, a hard disk drive (HDD) may be used, and a dynamic random access memory (DRAM) or the like may be used in conjunction therewith.

The recording head driver 110 causes the recording head 3 to eject ink from its nozzle in an amount corresponding to the pixel value in image data by supplying a drive signal corresponding to the image data to the recording head 3 at an appropriate timing under the control of the controller 100.

The conveyance driver 120 causes the conveyor belt 23 to rotationally move at a predetermined speed and timing by supplying a drive signal to the vertical scanning motor for the driving roller 21 under the control of the controller 100.

The input/output interface 130 mediates transmission and reception of data between the external device 6 and the controller 100. The input/output interface 130 includes, for example, any of various serial interfaces and various parallel interfaces, or a combination thereof.

The external device 6, which may be, for example, a personal computer, supplies an instruction to record an image (print job), image data, and the like to the controller 100 via the input/output interface 130.

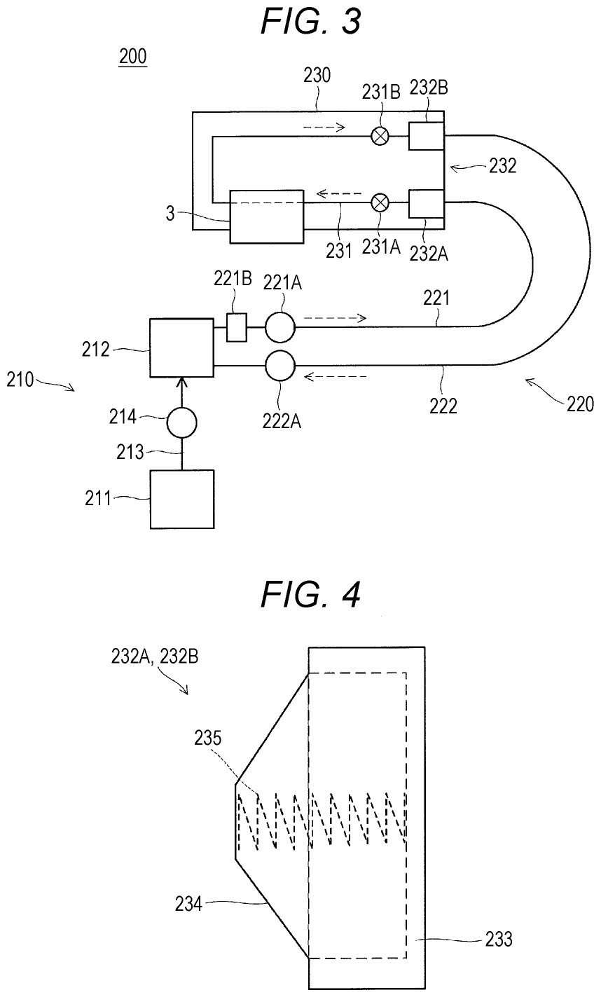

Now, the following describes the liquid flow path system 200 applied to the present embodiment. FIG. 3 is a diagram schematically illustrating the liquid flow path system 200 applied to the present embodiment.

As illustrated in FIG. 3, the liquid flow path system 200 includes a reservoir 210, a circulation path part 220, and a moving part 230. The reservoir 210, which is a part storing a liquid (ink) to be supplied to the above-described recording head 3, is provided at an appropriate position in the image forming apparatus 1 outside the moving part 230. The reservoir 210 includes a first tank 211, a second tank 212, and a replenishing flow path 213.

The first tank 211 stores a liquid therein, and is formed to be replenished with a liquid from the outside of the image forming apparatus 1. Note that the first tank 211 may be formed to be detachable from the image forming apparatus 1 so as to be replaced when the liquid runs out.

The second tank 212 stores a liquid therein, and is formed to be able to supply a liquid to the circulation path part 220 and to collect a liquid from the circulation path part 220.

The replenishing flow path 213 is a flow path for adding a liquid from the first tank 211 to the second tank 212. The replenishing flow path 213 is provided with a pump 214, and the pump 214 runs under the control of the controller 100 to feed the liquid in the first tank 211 to the second tank 212.

The circulation path part 220, which is a path part for circulating a liquid between the reservoir 210 and the moving part 230, includes a supply flow path 221 and a collection flow path 222. The supply flow path 221 and the collection flow path 222 include a flexible portion such as a tube, and are formed to be able to follow the movement of the moving part 230.

The supply flow path 221 is a flow path for supplying the liquid in the reservoir 210 to the moving part 230 (recording head 3). The supply flow path 221 is provided with a supply pump 221A, and the supply pump 221A runs under the control of the controller 100 so that a liquid flows through the supply flow path 221 from the reservoir 210 to the moving part 230 (communication path part 23 1), thereby feeding the liquid thereto. The supply pump 221A corresponds to a “first liquid feeder” of the present invention.

In addition, a degassing module 221B is provided in the supply flow path 221 between the reservoir 210 and the supply pump 221A. Thee degassing module 221B degases the liquid flowing through the supply flow path 221.

The collection flow path 222 is a flow path for returning the liquid in the moving part 230 (recording head 3) to the reservoir 210 to collect the liquid. The collection flow path 222 is provided with a collection pump 222A, and the collection pump 222A runs under the control of the controller 100 so that the liquid flows through the collection flow path 222 from the moving part 230 (communication path part 231) to the reservoir 210, thereby feeding the liquid thereto. The collection pump 222A corresponds to a “second liquid feeder” of the present invention.

The moving part 230 includes a carriage having the above-described recording head 3, and is movable in a scanning direction (predetermined direction) orthogonal to the conveying direction of the recording medium (for example, the horizontal direction in FIG. 3). The moving part 230 includes, in addition to the recording head 3, a communication path part 231 and a pressure adjuster 232.

The communication path part 231, which is a path communicating with the circulation path part 220, allows the supply flow path 221 and the collection flow path 222 to communicate with each other. The recording head 3 is provided between a portion (a first pressure generator 232A described. later) of the communication path part 231, the portion communicating with the supply flow path. 221, and a portion (a second pressure generator 23213 described later) thereof, the portion communicating with the collection flow path 222.

The communication path part 231 also communicates with an ejection flow path of a liquid ejector in the recording head 3. Therefore, a liquid flowing through the communication path part 231 is ejected from the ejector in the recording head 3.

In addition, a first solenoid valve 231A is provided between the first pressure generator 232A and the recording head 3 in the communication path part 231, while a second solenoid valve 231B is provided between the recording head 3 and the second pressure generator 232B in the communication path part 231.

The first solenoid valve 231A and the second solenoid valve 231B, which are known solenoid valves, are controlled at times when a liquid is circulated between the reservoir 210 and the moving part 230, when maintenance is carried out on the ejector in the recording head 3, and the like.

The pressure adjuster 232, which is provided in a portion of the communication path part 231, the portion communicating with the circulation path part 220, adjusts a pressure in order that the liquid supplied from the circulation path part 220 passes through the recording head 3 (ejector) and returns to the circulation path part 220.

The pressure adjuster 232 includes a first pressure generator 232A and a second pressure generator 232B. The first pressure generator 232A is provided in a portion of the communication path part 231, the portion communicating with the supply flow path 221. The second pressure generator 232B is provided in a portion of the communication path part 231, the portion communicating with the collection flow path 222.

As illustrated in FIG. 4, each of the first pressure generator 232A and the second pressure generator 232B includes a housing 233, a flexible part 234, and an energizer 235.

The housing 233 is formed into, for example, a box shape Opened on the left side as in FIG. 4, and is formed to be able to contain (store) a liquid. In this way, storing a liquid in the housing 233 makes it possible to easily adjust a pressure using the energizing force provided by the energizer 235.

In the housing 233, the supply flow path 221 or the collection flow path 222 communicates with the communication path part 231 so that a liquid is allowed to move between the supply flow path 221 or the collection flow path 222 and the communication path part 231 via the housing 233.

The flexible part 234 is made of a flexible member such as, for example, a flexible resin film and covers the opening of the housing 233. Examples of the flexible resin film include low-density polyethylene, high-density polyethylene, Teflon (registered trademark), saran vinyl chloride, polyvinyl alcohol, polypropylene, nylon, sic polyethylene terephthalate.

In addition, the flexible resin film is preferably the low-density polyethylene that is chlorine-free so as to be easily formed into a film and that has necessary and sufficient gas water vapor non-permeability. In the present embodiment, the flexible part 234 is made of low-density polyethylene and further includes a deposited film of aluminum or the like as a barrier layer.

The energizer 235, which is formed of, for example, a compression spring, is provided between the housing 233 and the flexible part 234 to energize the flexible part 234, thereby generating a pressure in the first pressure generator 232A and the second pressure generator 232B.

The energizing force is different between the energizer 235 in the first pressure generator 232A and the energizer 235 in the second pressure generator 232B. Specifically, the energizing force (for example, the spring constant) of the energizer 235 in the second pressure generator 232B is greater than the energizing force of the energizer 235 in the first pressure generator 232A.

The magnitude of the pressure (negative pressure) in each of the first pressure generator 232A and the second pressure generator 232B is determined by the force provided by the energizer 235 and the area (membrane area) of the flexible part 234.

More specifically, as the force provided by the energizer 235 or the force formed on the membrane surface of the flexible part 234 is greater, the degree of the negative pressure in each of the first pressure generator 232A and the second pressure generator 232B is greater. In addition, as the area of the flexible part 234 is larger, the degree of the negative pressure in each of the first pressure generator 232A and the second pressure generator 232B is smaller.

In the present embodiment, the energizing force of the energizer 235 in the second pressure generator 232B is greater than the energizing force of the energizer 235 in the first pressure generator 232A, and thus Inc second pressure generator 232B side has a negative pressure relative to the first pressure generator 232A side.

Therefore, there is created a flow of the liquid moving from the first pressure generator 232A to the second pressure generator 232B.

As a result, the liquid flows through the communication path part 231 from the portion communicating with the supply flow path 221 to the portion communicating with the collection flow path 222.

Specifically, the controller 100 controls the supply pump 221A and the collection pump 222A so that a liquid is fed to the first pressure generator 232A. More specifically, when the pressure in the first pressure generator 232A as measured by an air pressure sensor (not illustrated) is equal to or less than a first specified value, the supply pump 221A is run to feed the liquid to the first pressure generator 232A.

When the liquid is stored in the first pressure generator 232A and the pressure in the first pressure generator 232A becomes higher than the first specified value, the supply pump 221A is stopped. The first specified value can be set to any value suitable for the image forming apparatus 1.

On the other hand, when the pressure in the second pressure generator 232B as measured by an air pressure sensor (not illustrated) is equal to or less than a second specified value, the liquid moves from the first pressure generator 232A to the second pressure generator 232B.

When the liquid is stored in the second pressure generator 232B and the pressure in the second pressure generator 232B becomes higher than the second specified value, the collection pump 222A is run to feed the liquid to the reservoir 210. The second specified value can be set to any value suitable for the image forming apparatus 1. Thereafter, When the pressure in the second pressure generator 232B becomes equal to or lower than the second specified value as a result of feeding the liquid by the collection pump 222A, the collection pump 222A is stopped.

In this way, in the image forming apparatus 1. in operation according to the present embodiment, a liquid circulates between-the reservoir 210 and the moving part 230.

Then, the liquid flowing through the communication path part 231 is ejected from the ejector in a portion corresponding to the recording head 3 under the control of the controller 100. That is, in the present embodiment, the liquid is ejected while the liquid is in a flow of circulation.

In addition, the sum of the pressure in the first pressure generator 232A and the pressure in the second pressure generator 232B is set to be a negative pressure relative to the ejection surface of the recording head 3.

For example, supposing that the image forming apparatus 1 is stopped so that the supply pump 221A and the collection pump 222A stop feeding a liquid, the liquid stops flowing when the pressures in the first pressure generator 232A and the second pressure generator 232B balance each other.

Furthermore, since the individual pressures are set so as to attain the above-described relationship, the meniscus on the ejection surface is maintained. As a result, the need for a separate process for maintaining the meniscus is eliminated, thereby simplifying control in the image forming apparatus 1.

In addition, in the image forming apparatus 1 according to the present embodiment, the recording head 3 (ejector) is flushed. A branch flow path (not illustrated) is provided between the supply flow path 221 and the communication path part 231 so as to bypass the first pressure generator 232A. A switching valve (not illustrated) is provided at the connection between the supply flow path 221 and the branch flow path for switching the direction of a liquid flow between the first pressure generator 232A side and the branch flow path side.

To flush the recording head 3, the controller 100 moves the moving part 230 to, for example, the outside of an area of ejection onto the recording medium, closes the first solenoid valve 231A and the second solenoid valve 231B, and stops the collection pump 222A. Then, the controller 100 controls the switching valve so that the liquid flows through the branch flow path, and runs the supply pump 22A. Thus, the liquid is ejected from the ejector of the recording head 3.

Meanwhile, in a case where an image forming apparatus of scanning type is formed to eject a liquid from the reservoir in the moving part (carriage) to the ejector as in a conventional configuration, a problem such as a liquid drip or a meniscus break caused by the inertia in movement of the moving part may occur.

For example, when the moving part moves in the same direction as the direction in which the liquid flows from the reservoir to the ejector (from right to left in FIG. 3), momentum is given to the liquid flow by the inertia during movement of the moving part, that is, during acceleration of the moving part, and the amount of the liquid in the ejector is increased to cause a liquid drip. In addition, when the moving part stops On the most downstream side of the moving direction, a force acting to push back the liquid is applied by the inertia, and the amount of the liquid in the ejector is decreased to cause a meniscus break.

Furthermore, when the moving part moves in a direction opposite to the direction in which the liquid flows from the reservoir to the ejector (from left to right in FIG. 3), a force acting to push back the liquid flow is applied by the inertia during movement of the moving part, that is, during acceleration of the moving part, and thus the amount of the liquid in the ejector is decreased to cause a meniscus break. In addition, when the moving part stops on the most downstream side of the moving direction, a force acting in the liquid flow direction is applied by the inertia, and the amount of the liquid in the ejector is increased to cause a liquid drip.

In contrast, in the present embodiment, the liquid is ejected from the ejector while the liquid is in a flow of liquid circulation in the communication. path part 231. More specifically, the liquid is ejected front the ejector while the liquid is in a now of liquid circulation between the reservoir 210 located outside the moving part 230 and the moving part 230. Therefore, the liquid is unaffected by the inertia, unlike a conventional configuration in which the liquid flows in the moving part from the reservoir toward the ejector.

As a result, it is possible to suppress the occurrence of a problem caused by the inertia as seen in a conventional configuration.

In addition, in the configuration of the present embodiment, since the liquid is circulating, even when the liquid is not ejected from any of the individual ejection holes in the ejector, the liquid is always flowing through a portion corresponding to such ejection hole. Therefore, such ejection hole can be inhibited from becoming dry.

Meanwhile, a conventional image forming apparatus of one-pass type has difficulty in ejecting a liquid during refreshing (for example, the above-described flushing) because the recording head is fixed and the ejector is allowed to eject a liquid only onto a liquid ejection area in the recording medium.

On the other hand, a conventional image forming apparatus of scanning type can perform the flushing by moving the moving part to the outside of a liquid ejection area and ejecting a liquid to the outside of the liquid ejection area. However, a conventional image forming apparatus of scanning type poses a problem of an increased amount of a waste liquid because a liquid is frequently ejected including ejection of a liquid for maintenance work as well as ejection of a liquid for the flushing intended to inhibit ejection holes from becoming dry as described above.

In contrast, in the present embodiment, a liquid circulates between the reservoir 210 and the moving part 230, thereby inhibiting ejection holes from becoming dry. Therefore, although a liquid can be ejected to the outside of a liquid ejection area, it is unnecessary to frequently perform the flushing, which is ejecting the liquid to the outside of the liquid ejection area for the purpose of inhibiting ejection holes from becoming dry.

As a result, it is made possible to eject a liquid less frequently while inhibiting the ejector from becoming dry. In other words, the present embodiment makes it possible to inhibit the ejector from becoming dry while suppressing an increase in the amount of a waste liquid.

In addition, in a case where a liquid is ejected for the purpose of inhibiting ejection holes in the recording head 3 from becoming dry during image formation, a conventional image forming apparatus of seaming type is to print at lower speed because the moving part is to move across a greater breadth during image formation. In order to suppress a decrease in print speed, for example, it is necessary to reduce the scanning range outside a liquid ejection area. Furthermore, conventionally there is a possibility that, when a liquid is ejected to the outside of a liquid ejection area, the liquid scattered by the ejection adheres to the ejection surface.

In contrast, the present embodiment eliminates the need for ejecting a liquid for the purpose of inhibiting the recording head 3 from becoming dry because the liquid is circulating between the moving part 230 and the reservoir 210. As a result, unlike a conventional configuration, the occurrence of problems of lower print speed and adherence of a liquid to the ejection surface can be suppressed.

In addition, since the energizing force of the energizer 235 in the second pressure generator 232B is greater than the energizing force of the energizer 235 in the first pressure generator 232A, the amount of a liquid fed through the supply flow path 221 can be made larger than the amount of a liquid fed through the collection flow path 222.

As a result, the supply pump 221A and the collection pump 222A are allowed to run with substantially constant frequency, and therefore the operating life of the supply pump 221A and the collection pump 222A can be extended.

In addition, in a preferred configuration, each of the supply flow path 221 and the collection flow path 222 connecting the moving part 230 and the reservoir 210 has a greater length to some degree (for example, 5 m or more).

As a result, in the event that the liquid is heated because of ejection of the liquid from the recording head 3, the liquid can be cooled by passing through the relatively long supply flow path 221 and collection flow path 222. Therefore, the need for separately providing a cooling device for cooling the liquid is eliminated.

In the above embodiment, the energizing force of the energizer 235 is made different between the first pressure generator 232A and the second pressure generator 232B. However, the present invention is not limited thereto, and the energizing forces may be equal to each other.

In addition, in the above embodiment, the energizing force of the energizer 235 is made different between the first pressure generator 232A and the second pressure generator 232B, thereby creating a pressure difference. However, the present invention is not limited thereto, and a pressure difference may be created by any method. For example, the flexible part 234 in the first pressure generator 232A may have a larger area than the area of flexible part 234 in the second pressure generator 232B.

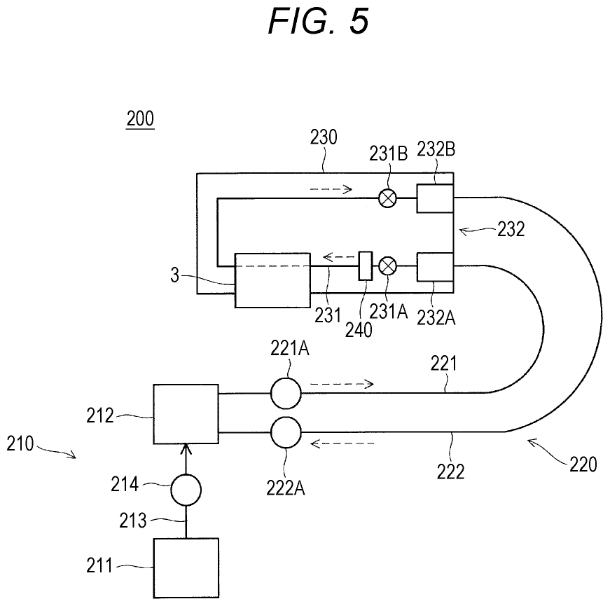

In the above embodiment, the degassing module 221E is provided between the reservoir 210 and the supply pump 221A in the supply flow path 221, but the present invention is not limited thereto. For example, as illustrated in FIG. 5, the degassing module 240 may be provided in the communication path part 231 within the moving part 230. The degassing module corresponds to a “denasser” of the present invention.

With this arrangement, the liquid can be degassed immediately before supplied to the recording head 3.

In the configuration of the above embodiment, a single recording head (ejector) is provided in the communication path part 231. However, the present invention is not limited thereto, and thus a plurality of recording heads (ejectors) may be provided.

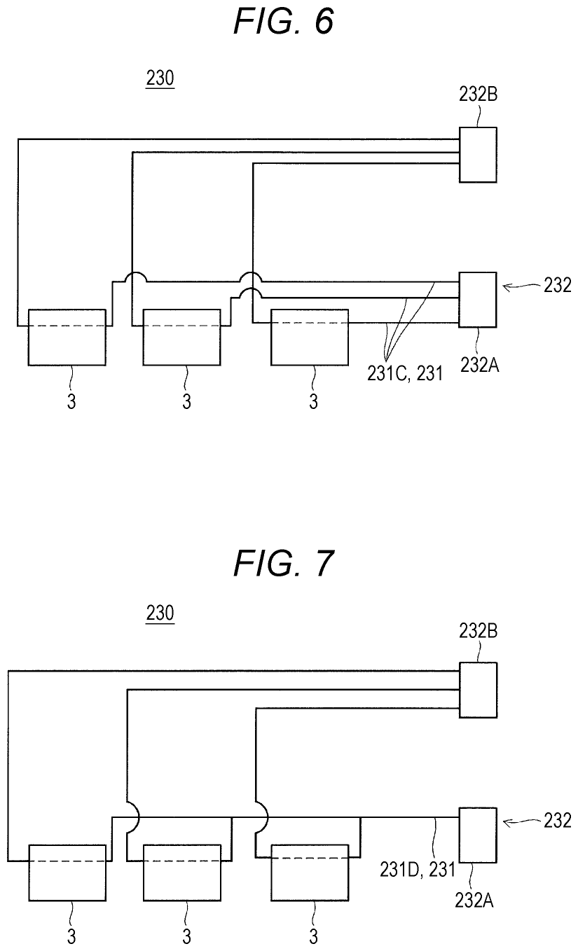

In this case, as illustrated in FIG. 6, the communication path part 231 may include, for example, a plurality of paths 2310 each communicating with. each of the plurality of recording heads.

As a result, the individual paths 231C (individual recording heads 3) are arranged in parallel, making it easier to adjust the pressure relationship for each of the paths 2310.

Alternatively, as illustrated in FIG. 7, the communication path part 231 may include a common path 231D that is in common communication with each of the plurality of recording heads.

With this arrangement, the piping from the common path 231D to each of the recording heads can be simplified.

In the above embodiment, the first pressure generator 232A and the second pressure generator 232B each have the housing 233 capable of storing a liquid. However, the present invention is not limited thereto but may have a configuration in which the housing 233 or the like is not provided, as long as the pressure in the communication path part 231 can be adjusted.

In the above embodiment, the reservoir 210 includes the first tank 211 and the second tank 212. However, the present invention is not limited thereto but may have a configuration in which, for example, the reservoir includes only one tank.

Although embodiments of the present invention have been described and illustrated in detail, the disclosed embodiments are made for purposes of illustration and example only and not limitation. The technical scope of the present invention should be interpreted by terms of the appended claims. That is, the present invention can be carried out in various forms without departing from the gist or main features of the present invention.

What is claimed is:

1. An image forming apparatus comprising:
a reservoir that stores a liquid;
a moving part that is movable in a predetermined direction; and
a circulation path part that allows the liquid in the reservoir to circulate between the reservoir and the moving part, wherein
the moving part includes:
an ejector that ejects the liquid to a recording medium;
a communication path part that communicates with an ejection-flow path of the ejector and communicates with the circulation path part; and
a pressure adjuster that is provided in a portion of the communication path part, the portion communicating with the circulation path part, and that adjusts a pressure in order that the liquid supplied from the circulation path part passes through the ejector and returns to the circulation path part.

2. The image forming apparatus according to claim 1, wherein
the circulation path part includes: a supply flow path through which a liquid supplied to the communication path part flows; and a collection flow path through which a liquid collected from the communication path part flows,
the pressure adjuster includes: a first pressure generator that is provided in a portion of the communication path part, the portion communicating with the supply flow path; and a second pressure generator that is provided in a portion of the communication path part, the portion communicating with the collection flow path, and
creates a pressure difference between the first pressure generator and the second pressure generator.

3. The image forming apparatus according to claim 2, wherein
the first pressure generator and the second pressure generator are capable of storing the liquid.

4. The image forming apparatus according to claim 3, wherein
each of the first pressure generator and the second pressure generator includes: a housing that stores the liquid; a flexible part that has flexibility and covers the housing; and an energizer that is provided between the housing and the flexible part and energizes the flexible part to generate a pressure.

5. The image forming apparatus according to claim 4, wherein
an energizing force of the energizer in the first pressure generator and an energizing force of the energizer in the second pressure generator are different from each other.

6. The image forming apparatus according to claim 5, wherein
the energizing force of the energizer in the second pressure generator is greater than the energizing force of the energizer in the first pressure generator.

7. The image forming apparatus according to claim 4, wherein
an area of the flexible part in the second pressure generator is larger than an area of the flexible part in the first pressure generator.

8. The image forming apparatus according to claim 4, further comprising:
a first liquid feeder that feeds the liquid from the reservoir to the supply flow path; and
a second liquid feeder that feeds the liquid from the collection flow path to the reservoir.

9. The image forming apparatus according to claim 4, wherein
a sum of the pressure in the first pressure generator and the pressure in the second pressure generator is a negative pressure relative to an ejection surface of the ejector.

10. The image forming apparatus according to claim 1, wherein
a plurality of the ejectors is provided.

11. The image forming apparatus according to claim 10, wherein
the communication path part includes a plurality of paths each communicating with each of the plurality of the ejectors.

12. The image forming apparatus according to claim 10, wherein
the communication path part includes a common path that communicates in communication with each of the plurality of the ejectors.

13. The image forming apparatus according to claim 1, further comprising:
a degasser that degasses the liquid, wherein
the degasser is provided in the moving part.
